(19) United States
(12) Patent Application Publication
(10) Pub. No.: US 2016/0371069 A1
(43) Pub. Date: Dec. 22, 2016

(54) APPARATUS AND METHOD FOR CLOUD-BASED DEVELOPMENT ENVIRONMENT SERVICE

(71) Applicant: ELECTRONICS AND TELECOMMUNICATIONS RESEARCH INSTITUTE, Daejeon (KR)

(72) Inventors: Su-Young BAE, Daejeon (KR); Wook-Ho SON, Daejeon (KR); Dong-Chun LEE, Daejeon (KR); Hun-Joo LEE, Daejeon (KR)

(21) Appl. No.: 15/083,345

(22) Filed: Mar. 29, 2016

(30) Foreign Application Priority Data
Jun. 22, 2015 (KR) 10-2015-0088130

(51) Int. Cl. G06F 9/445; G06F 9/455

(52) U.S. Cl. CPC G06F 8/60; G06F 9/455; G06F 9/44526

(57) ABSTRACT

An apparatus and method for a cloud-based development environment service. The apparatus for a cloud-based development environment service includes a development environment provision unit for providing development environments that are configured to develop an application and that correspond to multiple terminal devices, an emulation environment provision unit for providing emulation environments that are configured to verify execution of the application and that correspond to the multiple terminal devices, a customized environment configuration unit for configuring a customized environment based on both a development environment and an emulation environment corresponding to a terminal device designated by a client, among the multiple terminal devices, and a customized environment transmission unit for transmitting the customized environment to the client.

### CROSS REFERENCE TO RELATED APPLICATION

This application claims the benefit of Korean Patent Application No. 10-2015-0088130, filed Jun. 22, 2015, which is hereby incorporated by reference in its entirety into this application.

### BACKGROUND OF THE INVENTION

1. Technical Field

The present invention relates to an apparatus and method for creating device-collaborative content, in which two or more devices collaborate with each other to form a single service, based on a remote cloud.

2. Description of the Related Art

Conventional N-screen content service is service in which multiple terminals are seamlessly provided with a single piece of content, and is configured to provide content service suitable for media content, such as video or music, or to provide service in which a single piece of web content can be viewed in a manner compatible with various terminal environments. Here, even in the case of content involving collaboration between multiple terminals, only a Software Development Kit (SDK) suitable for each terminal is supported so as to develop content suitable for the corresponding terminal. Accordingly, there is difficulty in that, in order to verify collaboration between terminals, applications for respective terminals must be developed, and thereafter the applications must be actually installed in the terminals, and interoperability between the terminals must be verified.

### SUMMARY OF THE INVENTION

Accordingly, the present invention has been made to solve the conventional problem in the development of device-collaborative content, and an object of the present invention is to enable content to be developed, without the burdens of cost or failure of development during the course of content creation, by obviating the need to purchase a target terminal in which an application is to be installed.

Another object of the present invention is to provide an apparatus and method capable of simplifying an interoperability verification procedure because an application is installed in each terminal.

A further object of the present invention is to perform various types of interoperability verification on a single client by providing respective emulation environments for multiple terminals.

Yet another object of the present invention is to perform various types of interoperability verification without having to purchase multiple terminals, by providing respective emulation environments for multiple terminals in a cloud environment.

In accordance with an aspect of the present invention to accomplish the above objects, there is provided an apparatus for a cloud-based development environment service, including a development environment provision unit for providing development environments that are configured to develop an application and that correspond to multiple terminal devices; an emulation environment provision unit for providing emulation environments that are configured to verify execution of the application and that correspond to the multiple terminal devices; a customized environment configuration unit for configuring a customized environment based on both a development environment and an emulation environment corresponding to a terminal device designated by a client, among the multiple terminal devices; and a customized environment transmission unit for transmitting the customized environment to the client.

The customized environment configuration unit may configure a customized environment including multiple emulation environments so that interoperability between the emulation environments is capable of being verified.

At least one of the development environment and the emulation environment may be provided in a form of a plug-in.

At least one of the development environment and the emulation environment may include at least one of a hardware environment, an operating system, a library, and a device-collaborative Software Development Kit (SDK) of the corresponding terminal device.

Each terminal device may include at least one of a smart phone, a tablet, a smart Television (TV), a signage terminal, a digital menu board, an electronic blackboard, and a wearable device.

In accordance with another aspect of the present invention to accomplish the above objects, there is provided a method for a cloud-based development environment service, including providing development environments that are configured to develop an application and that correspond to multiple terminal devices, providing emulation environments that are configured to verify execution of the application and that correspond to the multiple terminal devices; configuring a customized environment based on both a development environment and an emulation environment corresponding to a terminal device designated by a client, among the multiple terminal devices; and transmitting the customized environment to the client.

Configuring the customized environment may include configuring a customized environment including multiple emulation environments so that interoperability between the emulation environments is capable of being verified.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for a cloud-based development environment service according to an embodiment of the present invention;

FIG. 2 is a block diagram showing the cloud-based development environment service apparatus shown in FIG. 1;

FIG. 3 is a block diagram showing an embodiment of device-collaborative content according to the present invention;

FIG. 4 is a block diagram showing another embodiment of device-collaborative content according to the present invention;

FIG. 5 is a block diagram showing a further embodiment of device-collaborative content according to the present invention;

FIG. 6 is a block diagram showing yet another embodiment of device-collaborative content according to the present invention; and

FIG. 7 is an operation flowchart showing a method for a cloud-based development environment service according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

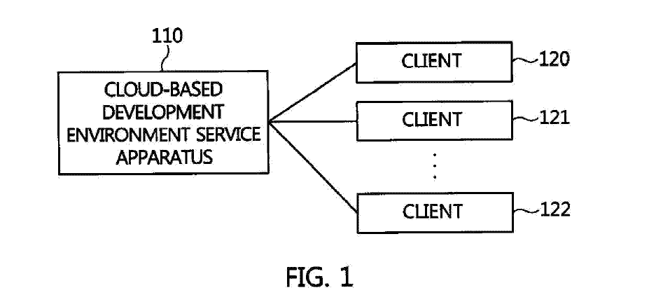

FIG. 1 is a block diagram showing a system for a cloud-based development environment service according to an embodiment of the present invention.

Referring to FIG. 1, the cloud-based development environment service system according to the embodiment of the present invention includes an apparatus 110 for a cloud-based development environment service and clients 120 to 122.

The cloud-based development environment service apparatus 110 provides a customized development environment to the clients 120 to 122.

Here, the customized development environment includes development environments and emulation environments corresponding to multiple terminal devices.

Each of the clients 120 to 122 develops an application using the customized development environment provided by the cloud-based development environment service apparatus 110, and verifies the operation of the developed application.

Here, all of the provision of the customized development environment, the development of an application using the customized development environment, and the verification of the developed application are performed in a cloud environment.

The customized development environment, which includes both the development environment and the emulation environment corresponding to the terminal device designated by each of the clients 120 to 122, among the multiple terminal devices, may be provided.

That is, an application supporting multiple terminal devices may be developed, and the developed application may be virtually executed and verified on the multiple terminal devices.

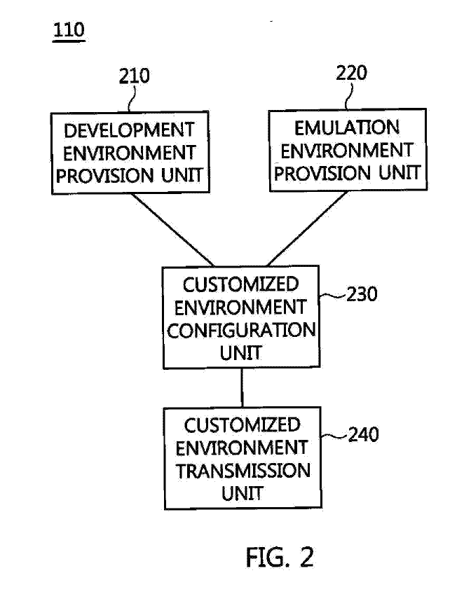

The provision of the customized development environment will be described in detail below with reference to FIG. 2.

FIG. 2 is a block diagram showing the cloud-based development environment service apparatus.

Referring to FIG. 2, the cloud-based development environment service apparatus shown in FIG. 1 includes a development environment provision unit 210, an emulation environment provision unit 220, a customized environment configuration unit 230, and a customized environment transmission unit 240.

The development environment provision unit 210 provides development environments that are configured to develop applications and that correspond to multiple terminal devices.

Here, the terminal devices may include at least one of a smart phone, a tablet, a smart TV, a signage terminal, a digital menu board, an electronic blackboard, and a wearable device.

The term “signage terminal” denotes a digital bulletin board on which various types of information and advertisements are provided by applying a digital display to an existing analog billboard, such as a poster, an indication board, or a signboard.

That is, each application may be executed on at least one of a smart phone, a tablet, a smart TV, a signage terminal, a digital menu board, an electronic blackboard, and a wearable device.

Further, the applications may be simultaneously executed on multiple terminal devices, and the multiple terminal devices may collaboratively create content while operating in conjunction with each other.

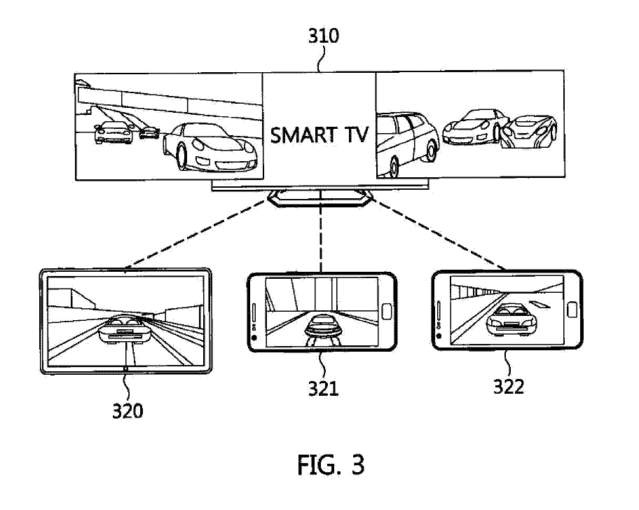

Embodiments of the application will be described in detail later with reference to FIGS. 3 to 6.

The emulation environment provision unit 220 provides emulation environments that are configured to verify the execution of the applications and that correspond to the multiple terminal devices.

That is, the applications may be virtually executed in respective emulation environments, rather than on actual terminal devices, and may thus be verified.

In conventional technology, to create device-collaborative content, a content development company must purchase terminal devices required for development and testing. Further, since, even for a single device, several tens of kinds of models are present depending on the manufacturer, operating system, provided performance, and hardware configuration, there is a considerable financial burden on the company.

According to the present invention, emulation environments suitable for the terminal devices are provided, and thus there is no need to purchase a target terminal device required to develop and test applications.

Here, at least one of a development environment and an emulation environment may be provided in the form of a plug-in.

Since the development environment and the emulation environment are provided in the form of a plug-in, functions may be easily extended whenever a terminal platform is added.

At least one of the development environment and the emulation environment may include at least one of the hardware environment, the operating system, the library, and the device-collaborative Software Development Kit (SDK) of the corresponding terminal device.

Therefore, processes ranging from development to execution verification of an application on the terminal device may be performed via a single procedure.

The customized environment configuration unit 230 configures a customized environment based on both the development environment and the emulation environment corresponding to the terminal device designated by a client among the multiple terminal devices.

In the development of applications, not all types of terminal devices are targeted, and thus a customized environment needs only to be configured based on both the development environment and the emulation environment corresponding to the terminal device designated by the client.

Here, the customized environment configuration unit 230 may configure a customized environment including multiple emulation environments such that interoperability between the emulation environments may be verified.

That is, applications are simultaneously executed in the multiple emulation environments, and interoperability and collaboration between the terminal devices may be verified.

The customized environment transmission unit 240 transmits the customized environment to the client.

That is, the customized environment transmission unit 240 transmits image and sound information conforming to the customized environment to the client.

Further, information about the development and testing, input by the client, is transmitted to the cloud-based development environment service apparatus and reflected therein in real time.

Although not shown in FIG. 2, the resources of the cloud-based development environment service apparatus must be used to provide the customized environment to the client and allow the client to perform development and testing using the customized environment. Thus, the cloud-based development environment service apparatus may further include a module for managing and allocating resources. Such a module allocates resources to respective clients so that the clients may use the resources and release the allocated resources when the development of an application is completed.

FIG. 3 is a block diagram showing an embodiment of device-collaborative content according to the present invention.

Referring to FIG. 3, the embodiment of device-collaborative content according to the present invention includes a smart TV 310, a tablet 320, and smart phones 321 and 322.

Each user may play a racing game using his or her tablet 320 or smart phone 321 or 322.

While playing the racing game, all playing or racing information is displayed on the smart TV 310.

For example, the overall map of the racecourse and the positions of respective players on the map may be displayed, and the current ranking or the like of all players may be displayed.

The embodiment of content in the present invention is not limited to the racing game, but may be used for all genres of games.

In the present embodiment, secondary information, which is not directly required for playing the game, is displayed on the smart TV 310, but the displayed information is not limited thereto.

For example, individual devices may be utilized in a way such that, on the tablet 320 or the smart phone 321 or 322, information that each user must privately know is displayed, and on the smart TV 310, information to be shared by all users is displayed, and such that the smart TV 310 is manipulated using the tablet 320 or the smart phone 321 or 322.

For example, multiple users may play a board game together such that the entire game board is displayed on the smart TV 310 and each user's own card, that is, information that must not be shown to other users, is displayed on the tablet 320 or smart phone 321 or 322 of each user.

In this way, the smart TV 310, the tablet 320, and the smart phones 321 and 322 execute respective applications, and may collaboratively create content while operating in conjunction with each other.

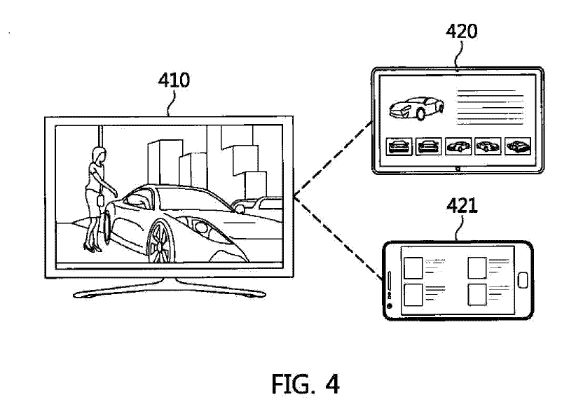

FIG. 4 is a block diagram showing another embodiment of device-collaborative content according to the present invention.

Referring to FIG. 4, another embodiment of the device-collaborative content according to the present invention includes a smart TV 410, a tablet 420, and a smart phone 421.

Users may view a drama together using the smart TV 410.

Further, respective users search for information associated with the content of the drama using the tablet 420 and the smart phone 421.

For example, a certain user may search for information about cars from makers sponsoring the drama using the tablet 420.

Meanwhile, another user may purchase the Original Sound Track (OST) of the drama using the smart phone 421.

That is, collaboration based on interoperation is realized such that each user may execute the corresponding application on the tablet 420 or the smart phone 421, and receive information about content currently being played on the smart TV 410 through the application.

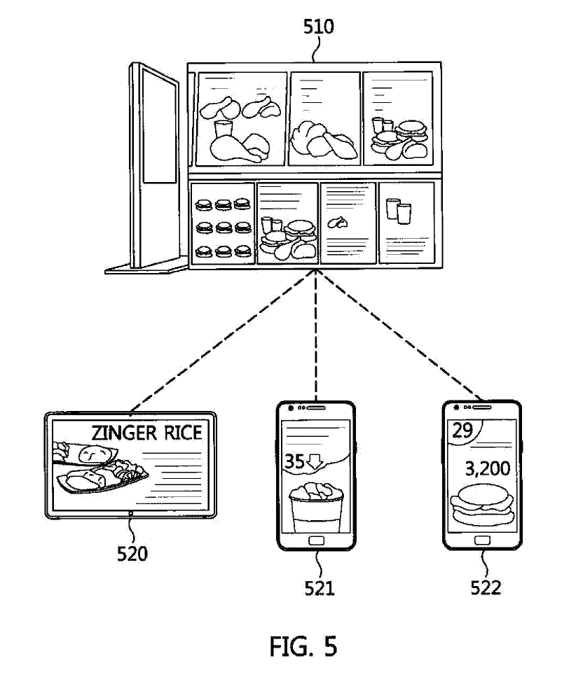

FIG. 5 is a block diagram showing a further embodiment of device-collaborative content according to the present invention.

Referring to FIG. 5, the further embodiment of device-collaborative content according to the present invention includes a digital menu board 510, a tablet 520, and smart phones 521 and 522.

On the digital menu board 510, menu items and prices thereof may be displayed like a normal menu board, but information about menu items and prices thereof may be transmitted in conjunction with other terminal devices.

Each of the tablet 520 and the smart phones 521 and 522 may execute the corresponding application, and the application may receive the information about the menu items and prices thereof.

For example, a certain user may view the menu items and prices thereof using his or her tablet 520. In this case, since the user views the information using his or her terminal device, there is an advantage in that more detailed information may be conveniently acquired, such as by viewing detailed information about a menu item of interest, compared to when viewing the information via the digital menu board 510.

Meanwhile, another user may view the promotional information of a menu item using the smart phone 521. That is, the promotional information that may be missed without being viewed may be provided by the digital menu board 510 to the smart phone 521.

Further, an additional user may order and pay for a desired, menu item using the smart phone 522.

That is, the user does not need to wait to order, wait for an employee to bring a menu board to his or her table, or wait to pay, and the details>of the order may be automatically reported to the digital menu board 510, and thus cooking based on the processing of the order may be performed in a kitchen.

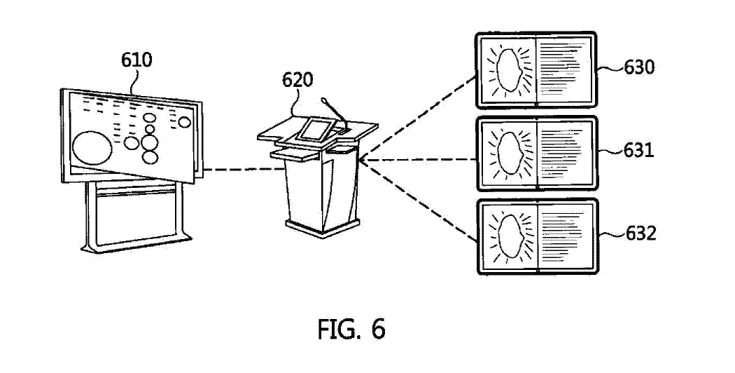

FIG. 6 is a diagram showing yet another embodiment of device-collaborative content according to the present invention.

Referring to FIG. 6, yet another embodiment of the device-collaborative content according to the present invention includes an electronic blackboard 610, an electronic lecture desk 620, and tablets 630 to 632.

The electronic blackboard 610, the electronic lecture desk 620, and the tablets 630 to 632 execute respective applications, and the applications of respective terminal devices operate in conjunction with each other.

For example, students register their attendance using their tablets 630 to 632, and a teacher may take attendance using the electronic lecture desk 620.

Further, through the use of the electronic lecture desk 620, learning, data may be shared among the tablets 630 to 632 of the students, or notices may be provided to the students.

Furthermore, content written on the electronic lecture desk 620 by the teacher may be displayed on the electronic blackboard 610, and the same content may be displayed on the tablets 630 to 632 of the students.

Aside from the sharing of learning data, the students may submit their homework or test answer sheets using the tablets 630 to 632, and the teacher may manage the homework or the test answer sheets using the electronic lecture desk 620.

That is, the applications executed on the electronic blackboard 610, the electronic lecture desk 620, and the tablets 630 to 632 may collaboratively create content while operating in conjunction with each other.

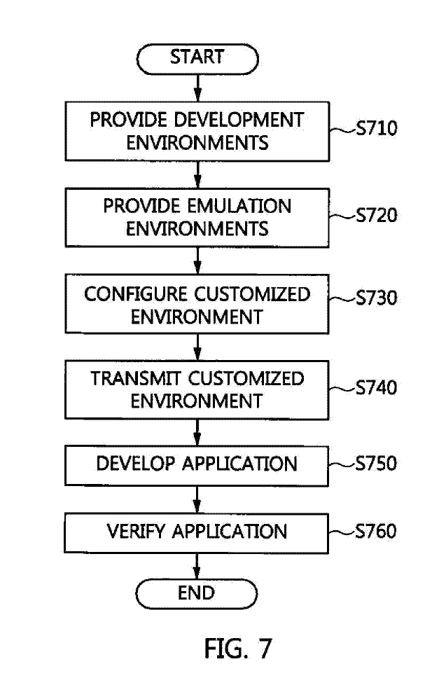

FIG. 7 is an operation flowchart showing a method for a cloud-based development environment service according to an embodiment of the present invention.

Referring to FIG. 7, the cloud-based development environment service method according to the embodiment of the present invention provides development environments that are configured to develop an application and that correspond to multiple terminal devices at step S710.

Here, the terminal devices may include at least one of a smart phone, a tablet, a smart TV, a signage terminal, a digital menu board, an electronic blackboard, and a wearable device.

The term “signage terminal” denotes a digital bulletin board on which various types of information and advertisements are provided by applying a digital display to an existing analog billboard, such as a poster, an indication board, or a signboard.

That is, each application may be executed on at least one of a smart phone, a tablet, a smart TV, a signage terminal, a digital menu board, an electronic blackboard, and a wearable device.

Further, the applications may be simultaneously executed on multiple terminal devices, and the multiple terminal devices may collaboratively create content while operating in conjunction with each other.

Further, the cloud-based development environment service method according to the embodiment of the present invention provides emulation environments that are configured to verify the execution of the application and that correspond to the multiple terminal devices at step S720.

That is, the applications may be virtually executed in respective emulation environments, rather than on actual terminal devices, and may thus be verified.

In conventional technology, to create device-collaborative content, a content development company must purchase terminal devices required for development and testing. Further, since, even for a single device, several tens of kinds of models are present depending on the manufacturer, operating system, provided performance, and hardware configuration, there is a considerable financial burden on the company.

According to the present invention, emulation environments suitable for the terminal devices are provided, and thus there is no need to purchase a target terminal device required to develop and test applications.

Here, at least one of a development environment and an emulation environment may be provided in the form of a plug-in.

Since the development environment and the emulation environment are provided in the form of a plug-in, functions may be easily extended whenever a terminal platform is added.

At least one of the development environment and the emulation environment may include at least one of the hardware environment, the operating system, the library, and the device-collaborative Software Development Kit (SDK) of the corresponding terminal device.

Therefore, processes ranging from development to execution verification of an application on the terminal device may be performed via a single procedure.

Next, the cloud-based development environment service method according to the embodiment of the present invention configures a customized environment based on both the development environment and the emulation environment corresponding to the terminal device designated by a client among the multiple terminal devices at step S730.

In the development of applications, not all types of terminal devices are targeted, and thus a customized environment needs only to be configured based on both the development environment and the emulation environment corresponding to the terminal device designated by the client.

Here, the step of configuring the customized environment may configure a customized environment including multiple emulation environments so that interoperability between the emulation environments may be verified.

That is applications are simultaneously executed in the multiple emulation environments, and interoperability and collaboration between the terminal devices may be verified.

Next, the cloud-based development environment service method according to the embodiment of the present invention transmits the customized environment to the client at step S740.

That is, the step of transmitting the customized environment is configured to transmit image and sound information conforming to the customized environment to the client.

Furthermore, in the cloud-based development environment service method according to the embodiment of the present invention, the client develops an application using the received customized environment at step S750.

At this time, information about development and testing input by the client is transmitted to the cloud-based development environment service apparatus and reflected therein in real time.

Thereafter, the cloud-based development environment service method according to the embodiment of the present invention verifies the execution of the application developed by the client and interoperability between the multiple terminal devices at step S760.

Although not shown in FIG. 7, since the resources of the cloud-based development environment service apparatus must be used to provide the customized environment to the client and allow the client to perform development and testing using the customized environment, the cloud-based development environment service method may further include the steps of allocating resources to the client and releasing the resources allocated to the client when the development of the application has been completed.

As described above, to solve the conventional problem in the development of device-collaborative content, the present invention enables content to be developed, without the burdens of cost or failure of development during the course of content creation, by obviating the need to purchase a target terminal in which an application is to be installed.

Further, the present invention may provide an apparatus and method capable of simplifying an interoperability verification procedure because an application is installed in each terminal.

Furthermore, the present invention may perform various types of interoperability verification on a single client, by providing respective emulation environments for multiple terminals.

As described above, in the apparatus and method for a cloud-based development environment service according to the present invention, the configurations and schemes in the above-described embodiments are not limitedly applied, and some or all of the above embodiments can be selectively combined and configured so that various modifications are possible.

What is claimed is:

1. An apparatus for a cloud-based development environment service, comprising:
a development environment provision unit for providing development environments that are configured to develop an application and that correspond to multiple terminal devices;
an emulation environment provision unit for providing emulation environments that are configured to verify execution of the application and that correspond to the multiple terminal devices;
a customized environment configuration unit for configuring a customized environment based on both a development environment and an emulation environment corresponding to a terminal device designated by a client, among the multiple terminal devices; and
a customized environment transmission unit for transmitting the customized environment to the client.

2. The apparatus of claim 1, wherein the customized environment configuration unit configures a customized environment including multiple emulation environments so that interoperability between the emulation environments is capable of being verified.

3. The apparatus of claim 2, wherein at least one of the development environment and the emulation environment is provided in a form of a plug-in.

4. The apparatus of claim 2, wherein at least one of the development environment and the emulation environment comprises at least one of a hardware environment, an operating system, a library, and a device-collaborative Software Development Kit (SDK) of the corresponding terminal device.

5. The apparatus of claim 2, wherein each terminal device comprises at least one of a smart phone, a tablet, a smart Television (TV), a signage terminal, a digital menu board, an electronic blackboard, and a wearable device.

6. A method for a cloud-based development environment service, comprising:
providing development environments that are configured to develop an application and that correspond to multiple terminal devices;
providing emulation environments that are configured to verify execution of the application and that correspond to the multiple terminal devices;
configuring a customized environment based on both a development environment and an emulation environment corresponding to a terminal device designated by a client, among the multiple terminal devices; and
transmitting the customized environment to the client.

7. The method of claim 6, wherein configuring the customized environment comprises configuring a customized environment including multiple emulation environments so that interoperability between the emulation environments is capable of being verified.

8. The method of claim 7, wherein at least one of the development environment and the emulation environment is provided in a form of a plug-in.

9. The method of claim 7, wherein at least one of the development environment and the emulation environment comprises at least one of a hardware environment, an operating system, a library, and a device-collaborative Software Development Kit (SDK) of the corresponding terminal device.

10. The method of claim 7, wherein each terminal device comprises at least one of a smart phone, a tablet, a smart Television (TV), a signage terminal, a digital menu board, an electronic blackboard, and a wearable device.
